(19) United States
(12) Patent Application Publication
(10) Pub. No.: US 2009/0207141 A1
(43) Pub. Date: Aug. 20, 2009

(54) TOUCH PAD FOR COMPUTER

(75) Inventors: Justin Tyler Dubs, Durham, NC (US); Harriss Christopher Neil Ganey, Cary, NC (US); James Joseph Thrasher, Efland, NC (US); Jennifer Greenwood Zawacki, Hillsborough, NC (US)

Correspondence Address: ROGITZ & ASSOCIATES, 750 B STREET, SUITE 3120, SAN DIEGO, CA, 92101, US

(73) Assignee: Lenovo (Singapore) Pte. Ltd.

(21) Appl. No.: 12/033,412

(22) Filed: Feb. 19, 2008

(51) Int. Cl. G06F 3/041

(52) U.S. Cl. 345/173

(57) ABSTRACT

A computer touch pad can be used for joystick-type navigation by allowing a user to touch her finger at a location on the pad that is distanced from a reference location of the pad, and the cursor is moved on screen the direction from the reference location to the touch down location at a speed that is proportional to the distance between the locations.

### FIELD OF THE INVENTION

The present invention generally relates to touch pads for controlling screen cursors in computers.

### BACKGROUND OF THE INVENTION

Notebook computer built-in cursor navigation is effected using either a joystick-like device such as a “Trackpoint” device or using a touch pad. System designers must choose one of the solutions, or have both in a system for additional cost. The touch pad navigation takes place by sliding a finger along a pad, while the joystick navigation takes place by using a finger to place pressure on a navigation stick in the desired direction of cursor travel. As understood herein, to provide for these two different user experiences, two separate input devices currently must be used.

### SUMMARY OF THE INVENTION

A method provides the user experience of joystick navigation while requiring only the touchpad in a system. The advantage is a reduced overall system cost while providing dual navigation experiences.

A computer has a monitor configured to display a screen cursor and a processor configured to control motion of the screen cursor on the monitor. A touch pad is configured to provide cursor motion input signals to the processor without requiring a user to slide a finger on the touch pad. If desired, the user can be given the option of enabling joystick navigation using the touch pad.

In some embodiments the touch pad has a reference point, and cursor motion is effected by a user touching the pad at a location distanced from the reference point without sliding a finger on the pad. Direction of cursor motion can be established by the direction between the reference point and the location, whereas speed of cursor motion can be determined by the distance between the reference point and the location.

The reference point can be immutable, in which case it cannot be established by the user, or the reference point can be established by the user. In the latter case, the reference point can be established by an initial finger touch down on the pad after the elapse of a threshold period of inactivity.

In another aspect, a method includes receiving a non-sliding finger touch at a touch location on a computer input device and determining a direction between the touch location and a reference location on the input device. The method also includes, based on the direction, moving a cursor on a computer screen.

In still another aspect, a tangible computer readable medium bears instructions executable by a processor for receiving a signal representing a user finger touch on a pad, the signal not indicating sliding motion, and determining motion of a screen cursor using the finger touch and a pad reference location distanced therefrom.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a perspective view of a computer that can use present principles, schematically showing internal components of the computer;

FIG. 2 is a plan view of the touchpad illustrating one implementation of cursor control;

FIG. 3 is a plan view of the touchpad illustrating another implementation of cursor control;

FIG. 4 is a plan view of a hardware-implemented touchpad showing some components in phantom; and

FIG. 5 is a flow chart showing a non-limiting implementation of the present logic.

### DETAILED DESCRIPTION OF THE PREFERRED EMBODIMENT

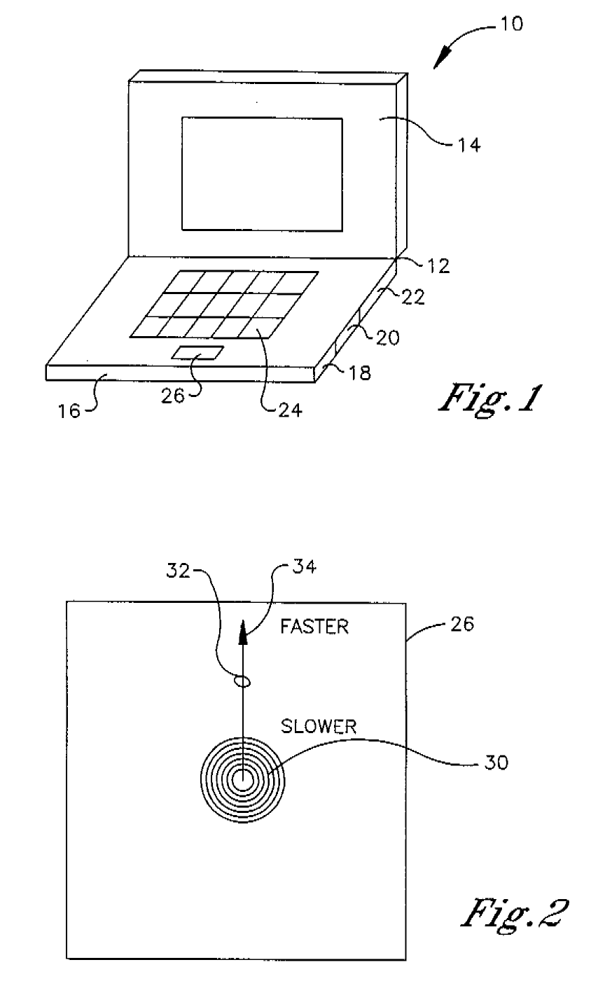

Referring initially to FIG. 1, a system is shown, generally designated 10, which includes a computer 12 such as but not limited to a notebook computer with a computer monitor 14 hingedly connected to a computer body 16. The computer body 16 can hold a processor 18 that may access one or more tangible computer-readable media such as but not limited to solid state non-volatile memory 20 and one or more magnetic or optical disk drives 22 that can contain instructions executable by the processor 18 in accordance with present principles.

The processor 18 can receive input from a key array 24 and a touchpad 26. As set forth further below, signals from the touchpad 26 are used by the processor 18 to establish the position and movement of a screen cursor on the monitor 14. The computer 12 need not have any joystick-style input device separate from the touch pad.

Now referring to FIG. 2, in this option, a visual cue 30 can be printed on the touchpad 26 (at, e.g., its center) to indicate a reference point. To move the cursor, the user simply touches the pad 26 at a location that is distanced from the reference point as indicated by the visual cue 30. The direction of cursor movement is determined by the direction vector from the reference point 30 to the finger touch down point 32, while the velocity of cursor movement is proportional to the length of the distance vector, with a greater distance resulting in a faster cursor motion as indicated by the arrow 34. The cursor moves as long as the user's finger is touched down, stationary. When the finger is lifted, cursor motion stops.

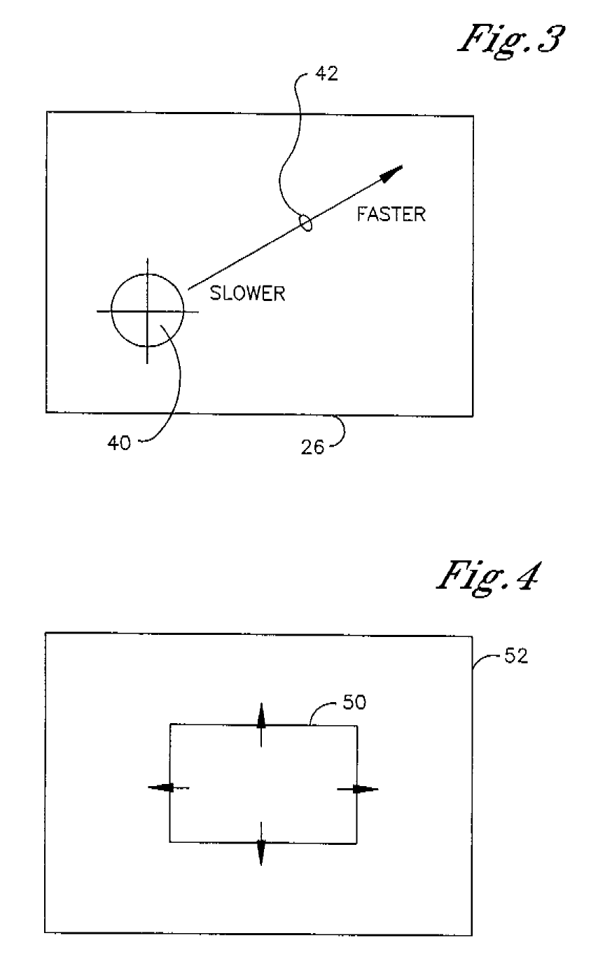

FIG. 3 shows that instead of a fixed reference point, a reference point 40 of the cursor can be determined based on where the user first places her finger. Navigation from that point occurs as above based on the second finger touch down at 42, i.e., is based on the length and magnitude of the distance vector from the initial touch down position to the second touch down position. The initial position can be reset based on a period of no pressure received on the touch pad for a threshold period, e.g., if no finger touch down has been received for a second or so, the next finger touch down can be considered to be the reference point and one immediately following establishes the end of the distance vector.

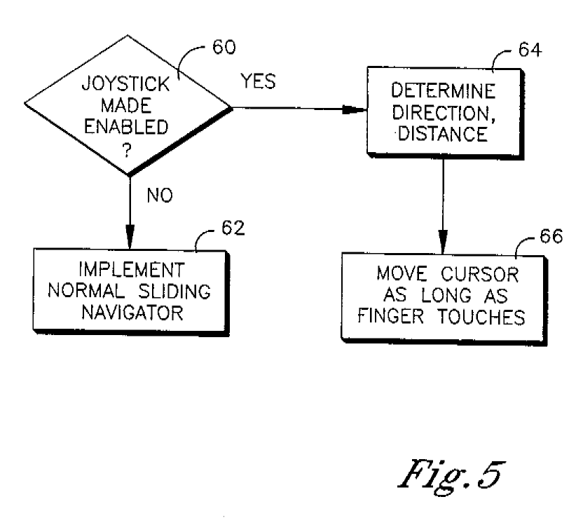

FIG. 4 shows a hardware implementation that uses a pressure sensor such as a strain gauge 50 placed under the center of a touch pad 52, which sends signals based on the direction and force of changing finger pressure over the center. The touch pad material can be either visually marked or have a slightly different texture to enable the user to determine the centerpoint easily.

FIG. 5 shows non-limiting logic that can be implemented. Commencing at decision diamond 60, it is determined whether the user has enabled joystick navigation. This can be done using a settings menu or by presenting, e.g., on power-up a user interface asking whether joystick navigation is to be enabled. If it is not, normal touchpad navigation is established at block 62, wherein the user moves the cursor by sliding his finger across the touchpad.

In other embodiments, the user can switch between “normal” touch pad operation and emulated joystick mode by using a specific pattern of taps (i.e. a triple tap) on the touchpad, or a dual simultaneous tap (touching the touchpad in two places to trigger the switch) or a gesture (such as swiping the finger in a circular pattern on the touch pad). Other methods of signaling that the user desires to switch to full emulation mode maybe used. For example, a touch-toggle indicator area may be printed directly on the touch pad itself (e.g., a small circle in one of the corners). Tapping that circle prior to touching the reference point would put the track pad into joystick emulation mode until that circle is tapped again. The circle area can be disallowed from being a touch down starting point in the user selected first reference point mode.

When joystick navigation is enabled, when a user subsequently touches her finger down at a location on the touchpad that is distanced from the reference point (without sliding the finger), the logic determines, at block 64, the direction from the reference to the touch down point and the distance between the two points. At block 66 the cursor is moved on the monitor 14 along the direction determined at block 64 at a speed that is proportional (e.g., that is directly proportional) to the distance determined at block 64. If desired, even when joystick mode is enabled, when sliding finger movement is detected on the touch pad the normal touch pad mode of navigation may be automatically entered.

While the particular TOUCH PAD FOR COMPUTER is herein shown and described in detail, it is to be understood that the subject matter which is encompassed by the present invention is limited only by the claims.

What is claimed is:

1. A computer comprising:
a monitor configured to display a screen cursor;
a processor configured to control motion of the screen cursor on the monitor; and
a touch pad configured to provide cursor motion input signals to the processor without requiring a user to slide a finger on the touch pad.

2. The computer of claim 1, wherein the user is given the option of enabling joystick navigation using the touch pad.

3. The computer of claim 1, wherein the touch pad has a reference point, and cursor motion is effected by a user touching the pad at a location distanced from the reference point without sliding a finger on the pad.

4. The computer of claim 3, wherein direction of cursor motion is established by the direction between the reference point and the location.

5. The computer of claim 4, wherein speed of cursor motion is determined by the distance between the reference point and the location.

6. The computer of claim 3, wherein the reference point cannot be established by the user.

7. The computer of claim 3, wherein the reference point is established by the user.

8. The computer of claim 7, wherein the reference point is established by an initial finger touch down on the pad after the elapse of a threshold period of inactivity.

9. A method, comprising:
receiving a non-sliding finger touch at a touch location on a computer input device;
determining a direction between the touch location and a reference location on the input device: and
based on the direction, moving a cursor on a computer screen.

10. The method of claim 9, comprising moving the cursor at a speed that is proportional to the distance between the locations.

11. The method of claim 9, wherein the input device is a touch pad.

12. The method of claim 11, comprising giving a user the option of enabling joystick navigation using the touch pad.

13. The method of claim 11, wherein direction of cursor motion is established by the direction from the reference location to the location.

14. The method of claim 13, wherein the reference location cannot be established by the user.

15. The method of claim 13, wherein the reference location is established by the user.

16. The method of claim 15, wherein the reference location is established by an initial finger touch down on the pad after the elapse of a threshold period of inactivity.

17. A tangible computer readable medium bearing instructions executable by a processor for:
receiving a signal representing a user finger touch on a pad, the signal not indicating sliding motion; and
determining motion of a screen cursor using the finger touch and a pad reference location distanced therefrom.

18. The medium of claim 17, wherein direction of cursor motion is established by the direction from the reference location and the location at which the user touched the pad.

19. The medium of claim 18, wherein speed of cursor motion is determined by the distance between the reference location and the location at which the user touched the pad.

20. The medium of claim 19, wherein cursor motion continues as long as the user touches the pad and stops in response to the user lifting the finger from the pad.
